(19) United States
(12) Patent Application Publication
(10) Pub. No.: US 2005/0125364 A1
(43) Pub. Date: Jun. 9, 2005

(54) Apparatus, and associated method, for dynamically pricing content responsive to quantitative demand indicia

(76) Inventors: David J. Edmondson, Southlake, TX (US); Mark C. Hill, Fort Worth, TX (US)

Correspondence Address: Robert H. Kelly;Scheef & Stone, L.L.P., Suite 1400, 5956 Sherry Lane, Dallas, TX, 75225, US

(21) Appl. No.: 10/773,894

(22) Filed: Feb. 6, 2004

Related U.S. Application Data
(60) Provisional application No. 60/527,070, filed on Dec. 4, 2003.

(51) Int. Cl. G06F 17/60

(52) U.S. Cl. 705/400

(57) ABSTRACT

Apparatus, and an associated method, for pricing content, such as musical or entertainment recordings, based upon quantitative demand for the content. An initial price indicia associator associates initial price indicia with the content files. The initial pricing is based upon historical indicia associated with the creators of the content. Thereafter, a price indicia adjuster adjusts the pricing of the content. The adjustments to the initial pricing and changes made thereafter are made responsive to detected indications of demand for the content.

### CROSS-REFERENCE TO RELATED APPLICATIONS

The present invention claims the priority of Provisional Patent Application No. 60/527,070, filed on 4 Dec. 2003, the contents of which are incorporated herein by reference.

The present invention relates generally to a manner by which to price content, such as recorded music, that is available for delivery to consumers of the content. More particularly, the present invention relates to apparatus, and an associated method, by which dynamically to price the content according to quantitative demand indicia, i.e., indications of actual demand, for the content.

Because the pricing is based upon indications of actual demand, the content is priced more efficiently than that permitted by conventional pricing mechanisms. And, as demand for the content changes, the pricing of the content also changes, dynamically to reprice the content. That is to say, the price of the content is increased, or decreased, depending upon changes in demand. Profit, distribution, or other criteria is better able to be maximized when the content is priced responsive to the indications of actual demand and repriced as demand for the content changes.

### BACKGROUND OF THE INVENTION

Technological advancements in digital, and other, communication technologies have permitted the development and deployment of new types of communication systems. New types of communication systems permit the effectuation of new types of communication services, many of which had previously been unavailable or prohibitively expensive to permit their use.

Many communication services, such as those permitted as a result of advancements in communication technologies, provide for the delivery of content to a consumer. Business content, entertainment content, and other types of content are delivered to a consumer pursuant to operation of a communication system. The content, originated at a content source, is communicated by way of a communication channel to a content destination. And, once the content is delivered to the content destination, the content is converted into human perceptible form, permitting the consumer of the content to perceive, e.g., listen to or read, the content.

In some communication systems, the content source and the content destination are interconnected by way of wireline connections. In some other communication systems, the content is communicated by way of the radio channels from the content source to the content destination. When the content is communicated by way of radio channels, the need for wireline connections by which to interconnect the entire communication path extending between the content source and the content destination is obviated.

A telephonic communication system is exemplary of a conventional wireline communication system that provides for the communication of content between a content source and a content destination. And, the Internet, or other packet data network, also provides for the communication of content between a content source and a content destination. As the Internet backbone permits the formation of relatively large bandwidth connections, the use of the Internet backbone through which to communicate content advantageously permits significant amounts of content to be communicated at relatively high rates.

Radio communication systems through which content is communicated by a content source to a content destination include, for example, conventional, terrestrial radio and television broadcasts and satellite-based radio, television, and other, broadcasts. Radio communication systems are also implementable in manners that provide large bandwidth connections.

Satellite-based communication systems advantageously provide large-area coverage areas, permitting point-to-multi-point communication services to be provided over large coverage areas. For instance, in recent years, satellite-based communication systems that provide for commercial television and radio broadcasts have achieved significant levels of usage and commercial success.

While many different types of communication systems are available through which to communicate content, consumers of content delivered by the aforementioned communication systems generally receive the content pursuant to purchases of subscriptions for the delivery of the content, or the consumers receive the content by way of non-paid broadcasts of the content.

And, while, particularly with respect to content communicated by way of the Internet, a consumer of content is able to purchase individual content files for delivery to a content destination, the pricing mechanisms used by which to price, and permit purchase of, the content files substantially correspond to the manners by which packaged content is normally priced and sold. That is to say, the content is priced and sold in manners that correspond substantially to the pricing and sale of content at conventional retail, and other, businesses. A price is established, e.g., using marketing studies or the like as the basis for establishing a price at which content is marketed and sold. Or, more simply, pricing at which content is priced is dependent upon standard, industry wide pricing norms.

While pricing of content in this manner is based on long traditions and is widely accepted, the conventional pricing mechanisms are, at their best, inexact indications of the most appropriate pricing of the content, both from the perspective of the content seller as well as the content consumer.

New communication systems that provide new manners by which to deliver content to a content consumer provide new opportunities by which better to price the content that is communicated therethrough. An improved manner by which to price the content that takes advantage of the capabilities of new digital communication systems would facilitate better optimal pricing of the content, both from the perspective of the content seller and the content consumer.

It is in light of this background information related to the delivery of content in a communication system to a content consumer that the significant improvements of the present invention have evolved.

### SUMMARY OF THE INVENTION

The present invention, accordingly, advantageously provides apparatus, and an associated method, by which to price content, such as recorded music, that is available for delivery to consumers of the content.

Through operation of an embodiment of the present invention, a manner is provided by which dynamically to price the content according to quantitative demand indicia for the content, such as consumer requests for the content.

Pursuant to operation of an embodiment of the present invention, pricing is based upon actual demand. The content is thereby priced more efficiently than that permitted by conventional pricing mechanisms. Pricing of the content need not be based merely upon anticipated levels of demand or upon industry norms that price content merely at normative pricing levels. Dynamic pricing of the content is permitted, thereby selectably to reprice the content as demand for the content changes.

When demand for the content increases, for example, the pricing of the content is selectably increased, better to maximize revenues when demand for the content is high. And, when demand for the content decreases, a decrease in the pricing of the content is implementable, if desired, to increase the demand for the content. Repricing of the content also facilitates maximization of other criteria, such as sales volume and profit.

In one aspect of the present invention, a database is maintained at which content files are stored. The content files each form a digital representation of a specific creation authored by a content creator. The content files are, for instance, in a selected format, such as a jpeg or MP3 format. Each content file is identified by content indicia, such as the name of the creator of the content of the content file. The content files stored at the database are indexed by the content indicia associated therewith, and the database is searchable therethrough. The content indicia, in one implementation, further identifies the content file by a title that also is indexable pursuant to operation of an embodiment of the present invention.

In another aspect of the present invention, a content creator database is created and maintained. The content creator database includes a listing formed of entries identifying the content creators of the content files stored at the content database. Historical indicia associated with the content creators listed in the content creator database are indexed together with the content creators. The historical indicia identifies, for instance, a prior sales history of other content created by the content creator. The prior sales history is represented, for instance, in the form of a categorization of prior sales. A content creator is categorized in one of a selected number of categories based upon prior sales history of the other content created by the content creator.

The historical indicia is used, for instance, to initially price content created by the content creators and stored at the content database. A content creator that exhibits a history of significant levels of sales of other content is initially accorded a categorization identifying the content creator's prior sales success. And, the categorization of the content creator is used during the initial pricing of the content file responsive to the category in which the content creator is categorized. If, conversely, the content creator has little or no sales history, the category in which the content creator is categorized indicates such, and the initial price by which the content is priced is responsive to the lack of sales history of the content creator.

While the initial price at which the content files stored at the content database are responsive to the historical indicia indexed together with the content creators maintained at the content creator database, the initial price associated with the content is adjusted responsive to demand for the content. A price indicia adjustor adjusts the price that is associated with the content files responsive to the requests therefor. The requests for the content, in one implementation, comprise inquiries regarding the availability of the content. In another implementation, the requests for the content comprise requests for purchase and downloading of the content. And, in another implementation, the requests for the content comprise actual purchases of, or other monetary transactions associated with, the content.

Indications of the requests for the content are provided to the price indicia adjustor on a real-time basis. That is to say, as the requests for the content are made by consumers of the content, the price indicia adjustor receives indications of the requests and adjusts the prices of the content files responsive thereto. The adjustments made by the price indicia adjustor are, in one implementation, incremental. That is to say, requests for the content, or absence of requests for content, within a selected time interval are used to adjust upwardly or downwardly the price associated with the content. Initially, the initial price is adjusted, but subsequent price adjustments are to adjust earlier-adjusted prices. Iterative operation of the pricing mechanism is thereby performed.

The incremental changes, in one implementation, form step-wise changes when selected thresholds of requests, or absence of requests, are made within a selected time period. In other implementations, the adjustments are made in other manners. In any event, the adjustments are dynamically made, responsive to quantifiable indicia of the demand for the content. More accurate pricing of the content, better to maximize a profit, distribution, sales, or other criteria is possible.

In these and other aspects, therefore, apparatus, and an associated method, is provided for a content distribution facility. The content distribution facility has a content database that stores a first content file and at least a second content file. A price indicia is associated with each of the first and at least second content files stored at the content database. An initial price indicia associator is adapted to receive content indicia associated with each of the first and at least second content files stored at the content database. The initial price indicia associator initially prices each of the first and at least second content files with initial price indicia. A price indicia adjuster is adapted to receive indications of the initial price indicia that the initial price indicia associator associates with each of the first and at least second content files. The price indicia adjuster also is adapted to receive indications of demand for each of the first and at least second content files. The price indicia adjuster adjusts the initial price indicia responsive to the demand therefor and forms adjusted price indicia associated with each of the first and at least second content files.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a content creation and distribution system in which an embodiment of the present invention is operable.

FIG. 2 illustrates a functional block diagram of a content distribution facility that forms a portion of the system shown in FIG. 1 and that includes an embodiment of the present invention therein.

FIG. 3 illustrates a flow chart that represents the method of operation of an embodiment of the present invention by which to price content that is available for distribution during operation of the system shown in FIG. 1.

### DETAILED DESCRIPTION

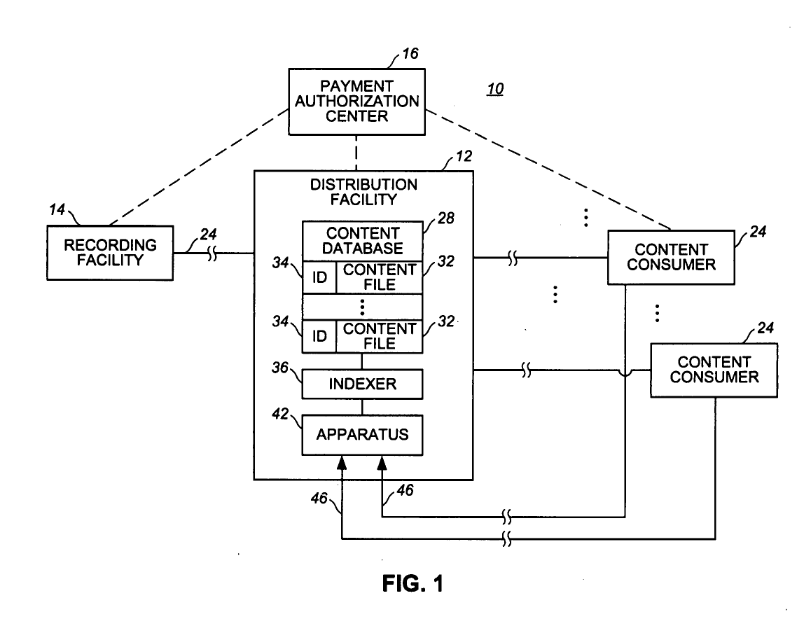

Referring first to FIG. 1, a content creation and distribution system, shown generally at 10, operates to provide for the creation of content, such as musical and other entertainment recordings for subsequent distribution to consumers thereof. The system is functionally represented and is implementable in any desired manner. For instance, various of the functional entities shown to form parts of the system are implemented as algorithms executable by processing circuitry in an exemplary implementation. And, additionally, in the exemplary implementation, elements of the system are distributed across separate physical locations. But, in other implementations, the elements of the system are co-located or distributed in other manners. Accordingly, while the following description of exemplary operation of the system 10 shall be described with respect to its implementation shown in FIG. 1, such description is not by way of such limitation but is exemplary only.

The system 10 includes a content distribution facility 12, a recording facility 14, and a payment authorization center 16. In the exemplary implementation, the facilities 12 and 14 and center 16 are positioned at separate locations, suitably connected theretogether by an appropriate communication medium, such as the Internet backbone. And, content consumers 18 are also shown in FIG. 1. The content consumers are representative of any consumer of content, e.g., individuals or business entities. The content consumers are also coupled to the content distribution facility by an appropriate communication medium, such as the Internet backbone or by way of a radio communication system.

The content recording facility 14 is here shown to be coupled to the content distribution facility 12 by way of a communication path 24. The content recording facility contains equipment that permits content creators to record content at the recording facility for subsequent uploading, or other delivery to, the content distribution facility by way of the communication path 24. More generally, the communication path 24 is representative of a path by which content is provided to the content distribution facility. That is to say, the path 24 is representative of a path by which to provide content, irrespective of its origin, to the content distribution facility. In other words, content provided to the content distribution facility is not limited to content recorded at a content recording facility 14, but includes content that is originated elsewhere and provided to the content distribution facility for subsequent copying and distribution therefrom.

The content distribution facility includes a content database at which content delivered to the content distribution facility is stored. In the event that the content delivered to the distribution facility is not in digital form, apparatus (not shown) embodied at the distribution facility digitizes the content or otherwise converts the content into a format or form permitting its storage at the database.

The database, in the exemplary implementation, is maintained at a computer server that is of a memory capacity permitting storage thereat of a large plurality of content files, selectably retrievable during operation of the content distribution facility. In the functional representation of the database shown in the figure, the database stores a plurality of content files 32, each of which is identified by a content identifier 34. The content identifier associated with each of the content files identifies, such as by title or content creator, or both, or in another manner, the content files associated therewith. The content files are selectably available for retrieval and copying for distribution to a content consumer 24. Elements that retrieve and copy the content are, e.g., embodied at a computer server at which the content files are stored.

And, an indexer 36 is also embodied at the content distribution facility. The indexer maintains an index of the content files 32 stored at the database 28. The index indexes together the content identifiers 34 with their locations in the database to facilitate identification of which content files are stored at the database and to identify where in the database the content files are stored to facilitate their retrieval and copying for distribution to a content consumer.

The content distribution facility further includes apparatus 42 of an embodiment of the present invention. The apparatus 42 is selectably operable to price the content files stored at the database for their purchase, i.e., copies of the content files, by content consumers. The pricing performed by the apparatus prices the content based upon quantitative indicia of the demand therefor. And, as demand for the content changes, the content is repriced. That is to say, as the quantitative indicia of the demand for the individual ones of the content files changes, the pricing of the individual ones of the content files is adjusted, or otherwise changed, to maintain the pricing of the content files at selected levels dependent upon the demand therefor.

Indicia of demand for individual ones of the content files is provided to the apparatus, here indicated by way of the lines 46. The lines 46 here indicate requests made by content consumers, such as the content consumer 24 for individual ones of the content files 32. The indicia associated with the requests include, for instance, indications of inquiries by the content consumers of the availability of the content files, requests for purchases of the content, and indications of purchase completions of the content by content consumers. In other implementations, other indicia is used by the apparatus to price individual ones of the content files based upon quantitative demand therefor.

The payment authorization center 16 here represents a third-party station, such as a credit card authorization location or electronic payment station that authorizes payment or accepts payment. The payment authorization center is involved in authorizing credit or electronic payment by a content consumer who elects to purchase one or more content files stored at the database 28.

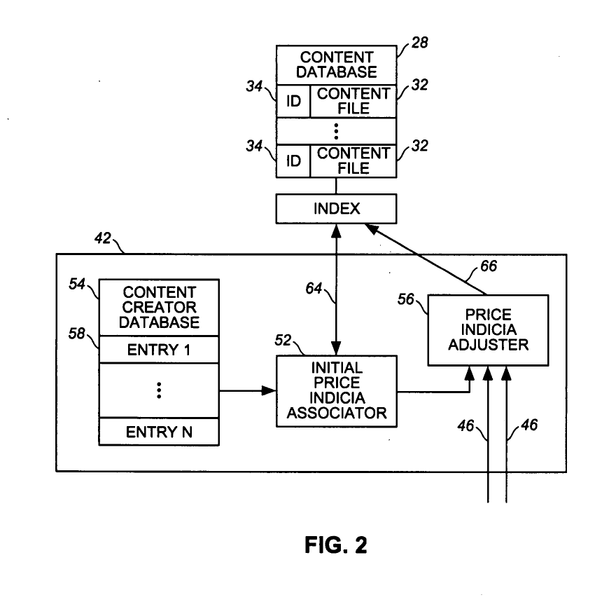

FIG. 2 again illustrates the content distribution facility 12 that forms a portion of the system 10 shown in FIG. 1. The facility, in the exemplary implementation, is operated by a facility operator and is located at any desired location that is permitting of communications with the content consumer 24, the payment authorization center 16, and the content recording facility 14 (all shown in FIG. 1).

Again, a database 28 is shown. The database stores and maintains a plurality of content files 32, each of which is identified by a content identifier 34. And, the indexer 36 that provides an index of the content files, identified by their content identifiers and their locations at the database 28 is also shown.

The apparatus 42 is again shown to form a portion of the content distribution facility. Elements of the apparatus 42 are functionally represented and are implementable in any desired manner, such as by algorithms executable by processing circuitry. In the exemplary implementation, the apparatus 42 and the database 28 are positioned at a common location. In other implementations, the apparatus and database are distributed at separate locations and suitably connected theretogether by way of appropriate connections.

The apparatus is here shown to include an initial price indicia associator 52, a content creator database 54, and a price indicia adjuster 56. The apparatus operates to associate pricing indicia with the content files, such as prices for purchase by a content consumer of copies of one or more content files stored at the database. The pricing indicia formed by the apparatus is, in the exemplary implementation, provided to the index 36 and indexed together with the associated content identifiers that identify the associated content files. And, during operation of the apparatus, dynamic adjustments to the pricing by which the apparatus prices the content files is performed, and the adjusted, i.e., repriced, pricing is stored at the index 36, replacing earlier-stored values thereof. Thereby, a current pricing associated with the content files is maintained at the index 36.

The initial price indicia associator 52 operates to form the initial pricing associated with the content files. Initial pricing provided by the initial price indicia associator is made responsive to information stored at the content creator database 54. The content creator database includes a listing formed of entries 58 that identify content creators, or other content identifiers analogous to the identifiers 34 that identify the content files 32 of the database 28, together with historical indicia associated with the content creators associated therewith. The historical indicia identifies, for instance, a sales history of other content created by the content creators listed in the listing. The prior sales history, in one implementation, is a numerical value, and, in another implementation, the sales value is a categorical value. When the sales value is a categorical value, the content creator is categorized into a selected group depending upon the sales history of the content creator. An initial price is formed by the initial price indicia associator responsive to retrieval information from the listing maintained at the content creator database. And, indications of the initial pricing are provided to the index 36, here by way of the line 64, to identify the initial pricing formed by the associator to the index 36.

Indications are also provided to the price indicia adjuster 56. The price indicia adjuster is also coupled to the lines 46 to receive indications of demand for the content. Responsive to the demand, the adjuster 56 adjusts the initial pricing of the index 36. And, during subsequent operation, readjustments of the pricing is made to reprice the content with such repricing also provided to the index by way of the line 66 to maintain an up-to-date indication of the pricing of the content based upon up-to-date demand therefor.

In one implementation, the initial pricing performed by the initial price indicia associator assigns the initial classification levels to individual ones of the content files. The initial classification levels, CLᵢ is based on the historical indicia retrieved from the content creator database 54. These values are provided to the index 36 and to the adjustor 56. Initially, at the adjuster, the classification level, CLₙ=CLᵢ. And, the demand for individual content files is monitored by way of the indications provided on the lines 46. The classification level is changed based upon detected indications of demand therefor. That is to say, CLₙ₊₁=CLₙ+? where ? is related to the demand for the content files, either negative or positive. In one implementation, the change is cumulative and incremental. That is to say, the adjuster incrementally readjusts the prices at which the adjuster prices the individual ones of the content files. The incremental changes are a function of the demand indicated by the indications provided to the adjuster on the lines 46 and, in one implementation, the adjustments are stepwise related to the demand.

Additional criteria, in a further implementation, is used by which to adjust the price. For instance, the delivery mechanism by which the content is to be delivered to the content consumer is used to perform price gradations at a particular demand level. For instance, a content file is priced at a first price gradation when the content file is to be delivered to a content consumer by way of a first delivery mechanism. And, the same content file is priced at a second price gradation when the content is to be delivered to a content consumer by way of another delivery mechanism. Other gradations price the same content differently depending upon the content consumer. For instance, if the content consumer is a non-commercial consumer, such as an individual, the content is priced at a gradation that differs with the pricing gradation of the content that is to be delivered to a commercial content consumer.

Additionally, adjustments made by the adjuster in a further implementation are made at selected intervals, such as at periodic intervals or at intervals defined by demand changes reaching selected thresholds. In any of the various implementations, the content is priced dynamically and based upon actual demand therefor. And, the price adjustments, in one implementation, are made to maximize a performance criteria, such as to maximize profit, to maximize sales, or to maximize another performance criteria.

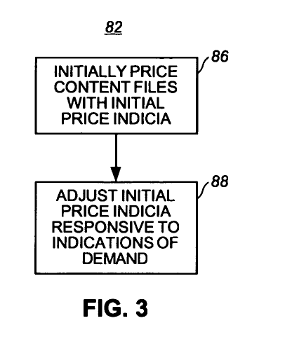

FIG. 3 illustrates a flow diagram, shown generally at 82, representative of operation of an embodiment of the present invention by which to price content stored at a content database and selectably available for purchase, or other use, by a content consumer. The content stored at the database is formed of a plurality of content files, including a first content file and at least a second content file.

First, and as indicated by the block 86, each of the first and at least second content files are initially priced with initial price indicia. The initial pricing is responsive to content indicia associated with each of the content files.

Then, the initial price indicia is adjusted responsive to indications of demand for each of the content files thereby to form adjusted price indicia associated with each of the content files.

Because the pricing by which the content files are priced is responsive to actual demand for the content, more efficient pricing facilitating maximization of pricing criteria is better able to be made.

The previous descriptions are of preferred examples for implementing the invention, and the scope of the invention should not necessarily be limited by this description. The scope of the present invention is defined by the following claims.

1. In a content distribution facility having a content database for storing a first and at least a second content file, an improvement of apparatus for associating a price indicia with each of the first and at least second content files stored at the content database, said apparatus comprising:
an initial price indicia associator adapted to receive content indicia associated with each of the first and at least second content files stored at the content database, said initial price indicia associator for initially pricing each of the first and at least second content files with initial price indicia;
a price indicia adjuster adapted to receive indications of the initial price indicia that said initial price indicia associator associates with each of the first and at least second content files and to receive indications of demand for each of the first and at least second content files, said price indicia adjuster for adjusting the initial price indicia responsive to the demand therefore and for forming adjusted price indicia associated with each of the first and at least second content files.

2. The apparatus of claim I wherein the first and at least second content files are authored by content creators and wherein the content indicia associated with each of the first and at least second content files comprise identifiers that identify the content creators of the first and at least second content files, respectively.

3. The apparatus of claim 2 further comprising a content creator database accessible by said initial price indicia associator, said content creator database forming an author index that indexes a listing of content creators together with historical indicia associated therewith, and wherein the initial price indicia with which said initial price indicia associator initially prices the first and at least second content files is responsive to the historical indicia stored at said content creator database.

4. The apparatus of claim 3 wherein the historical indicia responsive to which said initial price indicia associatro initially prices the first and at least second content files identifies historical demand for content files authored by the content creators indexed together therewith.

5. The apparatus of claim 4 wherein the initial price indicia with which said initial price indicia associator associates with the first and at least second content files is directly related, at least in a stepwise manner, with the historical demand.

6. The apparatus of claim 4 wherein the historical indicia indexed together with the content creator at the author index formed at said content creator database that identifies the historical demand categories the historical demand into a first historical demand level at least a second historical demand level.

7. The apparatus of claim I wherein the first content file and the at least the second content file stored at the content database is at least selectably available for delivery to content content consumers and wherein the indications of the demand to which said price indicia adjuster is adapted to receive comprise indications related to inquiries relating to individual ones of the first and at least second content files.

8. The apparatus of claim 7 wherein copies of the first and at least second content files are at least selectably available for purchase by the content consumers and wherein the inquiries selecting to the individual ones of the first and at least second content files comprise inquiries relating to purchase of copies of the individual ones of the first and at least second content files.

9. The apparatus of claim 8 wherein the inquiries relating to the purchase of the copies of the individual ones of the first and at least second content files comprise indications of purchase requests made by the content consumers.

10. The apparatus of claim 8 wherein the inquiries relating to the purchase of the copies of the individual ones of the first and at least second content files comprise indications of purchase completions made by the content consumers.

11. The apparatus of claim 1 wherein said price indicia adjuster interactively adjusts the adjusted price indicia associated with each of the first and at least second content files.

12. The apparatus of claim 1 wherein the indications of demand to which said price indicia adjuster is adapted to receive are applied to said price indicia adjuster at least at successive intervals, dynamically to receive the indications of the demand, and wherein said price indicia adjuster further successively forms the adjusted price indicia responsive to the indications of the demand received at the at least the successive intervals.

13. The apparatus of claim 12 wherein the adjusted price indicia formed by said price indicia adjuster formed at least at the successive intervals incrementally changes prior-formed values of the adjusted price indicia.

14. The apparatus of claim 1 further comprising a revenue allocator adapted to receive the indications of demand, said revenue allocator for allocating revenues associated with the first and at least second content files.

15. In a method for distributing content stored at a content database, the content formed of a first content file and at least a second content file, an improvement of a method for associating a price indicia with each of the first and at least second content files stored at the content database, said method comprising:
initially pricing each of the first and at least second content files with initial price indicia responsive to content indicia associated with each of the first and at least second content files; and
adjusting the initial price indicia with which the first and at least second content files are initially priced during said operation of initially pricing responsive to indications of demand for each of the first and at least second content files to form adjusted price indicia associated with each of the first and at least second content files.

16. The method of claim 15 wherein the first and at least second content files are authored by content creators and wherein the content indicia responsive to which the first and at least second content files are initially priced comprise identifiers that identify the content creators of the first and at least second content files, respectively.

17. The method of claim 16 further comprising the operation of associating historical indicia with the identifiers that identify the content creators of the content files and wherein the initial price indicia with which the first and at least second content files are initially priced during said operation of initially pricing is related to the historical indicia.

18. The method of claim 16 wherein copies of the first content file and the at least the second content file each are at least selectably available for delivery to content consumers and wherein the indications of the demand for each of the first and at least second content files comprise indications of requests made by the content consumers comprise indications related to at least requests for copies of selected ones of the first and at least second content files.

19. The method of claim 16 wherein said operation of adjusting the initial price indicia further comprises adjusting the adjusted price indicia.

20. The method of claim 17 wherein adjustments to the adjusted price indicia during said operation of adjusting are performed incrementally.
